(19) United States
(12) Patent Application Publication
(10) Pub. No.: US 2023/0054541 A1
(43) Pub. Date: Feb. 23, 2023

(54) ELECTRONIC APPARATUS

(71) Applicant: KYOCERA Document Solutions Inc., Osaka (JP)

(72) Inventor: Tetsuro Kitamura, Osaka (JP)

(21) Appl. No.: 17/886,001

(22) Filed: Aug. 11, 2022

(30) Foreign Application Priority Data
Aug. 19, 2021 (JP) 2021-134390

(51) Int. Cl. G06F 3/041; G06F 3/04886

(52) U.S. Cl. CPC G06F 3/0418; G06F 3/04886

(57) ABSTRACT

An electronic apparatus includes a display device, a touch panel arranged on the display device, and a user interface control unit. The display device is configured to display an operation screen. The user interface control unit is configured to detect a user operation to the operation screen using the touch panel, and perform a process corresponding to the detected user operation. Further, after the touch panel detects a touch at a touch position, if the user interface control unit detects a continuous movement of the touch position over a predetermined distance, the user interface control unit detects this touch as a wiping operation, and excludes this touch from a user operation to the operation screen.

### CROSS REFERENCE TO RELATED APPLICATIONS

This application relates to and claims priority rights from Japanese Patent Application No. 2021-134390, filed on August 19th, 2021, the entire disclosures of which are hereby incorporated by reference herein.

### BACKGROUND

### 1. Field of the Present Disclosure

The present disclosure relates to an electronic apparatus.

### 2. Description of the Related Art

An image processing apparatus distinguishes and detects an instruction operation to a display screen of a display device and a wiping operation for cleaning the display screen from each other using a touch panel, and changes a display mode from one to the other among a normal mode and a cleaning mode in accordance with the number of detection times of the wiping operation.

In the aforementioned image processing apparatus, a detection area of the touch panel is divided into plural divisional areas, an operation within a single divisional area is detected as the instruction operation, and an operation over at least two divisional areas is detected as the wiping operation.

However, in the aforementioned image processing apparatus, the instruction operation near a boundary between the divisional areas may be detected improperly as the wiping operation.

### SUMMARY

An electronic apparatus according to an aspect of the present disclosure includes a display device, a touch panel arranged on the display device, and a user interface control unit. The display device is configured to display an operation screen. The user interface control unit is configured to detect a user operation to the operation screen using the touch panel, and perform a process corresponding to the detected user operation. Further, after the touch panel detects a touch at a touch position, if the user interface control unit detects a continuous movement of the touch position over a predetermined distance, the user interface control unit detects this touch as a wiping operation, and excludes this touch from a user operation to the operation screen.

These and other objects, features and advantages of the present disclosure will become more apparent upon reading of the following detailed description along with the accompanied drawings.

### BRIEF DESCRIPTION OF THE DRAWINGS

FIG. 1 shows a perspective view diagram that indicates an electronic apparatus according to an embodiment of the present disclosure;

FIG. 2 shows a block diagram that indicates a configuration of an image forming apparatus 1 shown in FIG. 1;

FIG. 3 shows a diagram that indicates an example of an operation panel 11 shown in FIGS. 1 and 2; and

FIG. 4 shows a diagram that indicates an example of an operation screen including a slider.

### DETAILED DESCRIPTION

Hereinafter, an embodiment according to an aspect of the present disclosure will be explained with reference to drawings.

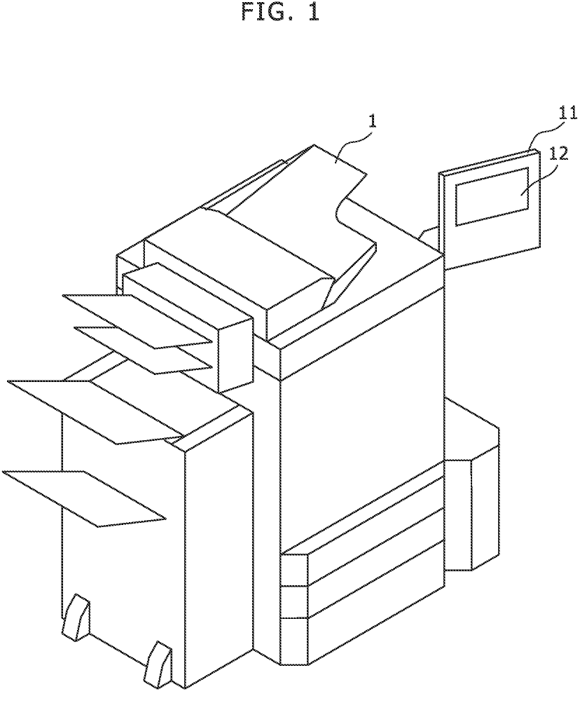

FIG. 1 shows a perspective view diagram that indicates an electronic apparatus according to an embodiment of the present disclosure. An image forming apparatus 1 shown in FIG. 1 is an example of an electronic apparatus such as copier or multi function peripheral, and includes an operation panel 11; and in the operation panel 11, a touch panel 12 is installed. In this embodiment, the image forming apparatus 1 is indicated as an example of the electronic apparatus, but the electronic apparatus may be another electronic apparatus including a touch panel, such as smart phone.

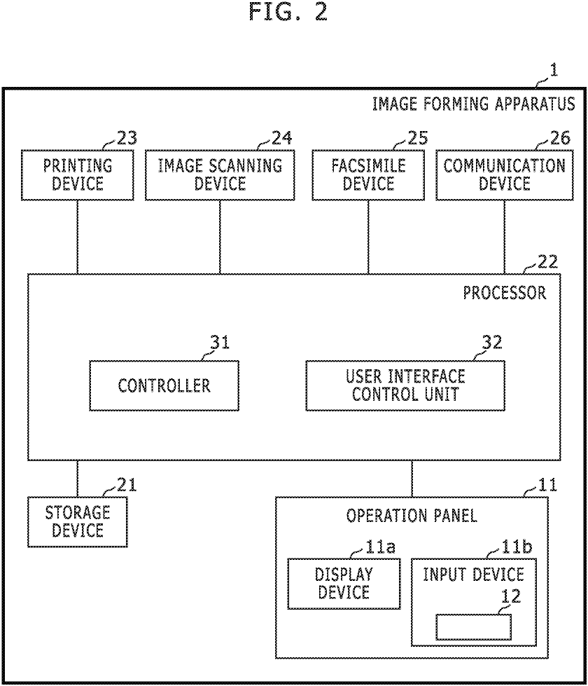

FIG. 2 shows a block diagram that indicates a configuration of an image forming apparatus 1 shown in FIG. 1. As shown in FIG. 2, the image forming apparatus 1 includes not only the aforementioned operation panel 11 but a storage device 21, a processor 22, a printing device 23, an image scanning device 24, a facsimile device 25, a communication device 26, and the like.

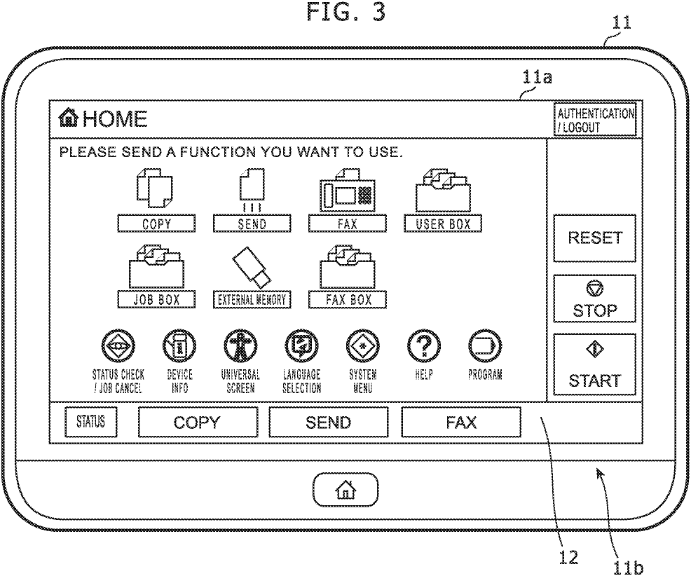

FIG. 3 shows a diagram that indicates an example of an operation panel 11 shown in FIGS. 1 and 2. The operation panel 11 is an internal device that is arranged on a front side of a housing of the image forming apparatus 1, and includes a display device 11a such as a liquid crystal display and an input device 11b such as a hard key and the touch panel 12, as shown in FIG. 3 for example. The display device 11a displays sorts of operation screens to a user. The touch panel 12 is arranged on the display device 11a, and the touch panel 12 and a key image or the like displayed on the display device 11a form a soft operation part such as a soft key. The input device 11b detects a user operation inputted by a user to the hard key or the soft key.

The storage device 21 is a nonvolatile rewritable storage device such as a flash memory. The processor 22 is a computer that includes a CPU (Central Processing Unit), a ROM (Read Only Memory), a RAM (Random Access Memory) and the like, and loads a program to the RAM from the storage device 21 or the ROM and executes the program using the CPU and thereby acts as sorts of processing units. Here, the processor 22 acts as a controller 31 and a user interface control unit 32.

The printing device 23 is an internal device that performs printing of an image specified by a job request in accordance with the job request such as a print job request or a copy job request based on a user operation. Further, the image scanning device 24 is an internal device that optically scans a document image from a document sheet and generates image data of the document image in accordance with a copy job request or the like based on a user operation. Furthermore, the facsimile device 25 is an internal device that generates and transmits a facsimile signal of an image specified by a facsimile transmission job request based on a user operation in accordance with the facsimile transmission job request, and receives a facsimile signal from an external device and generates image data from the received facsimile signal. The communication device 26 is an internal device that performs data communication with an external device, such as a wireless or wired interface (network interface or peripheral device interface).

In accordance with a user operation to an operation screen displayed on the operation panel 11, the controller 31 controls the aforementioned internal device and thereby performs a job specified by a job request, and performs transition of the operation screen.

The user interface control unit 32 detects a user operation to the operation screen (i.e. an operation panel including the soft operation part) using the touch panel, and performs a process corresponding to the detected user operation (i.e. screen transition, outputting an instruction to the controller 31 such as job request, or the like).

Further, after the touch panel 12 detects a physical touch at a touch position, if the user interface control unit 32 detects a continuous movement of the touch position over a predetermined distance, the user interface control unit 32 detects this touch as a wiping operation, and excludes this touch from a user operation to the operation screen. Therefore, even when the touch is detected on a display position of a soft key or the like, if the touch is detected as a wiping operation, then the touch is excluded from a user operation to the operation screen.

When detecting the user operation to the operation screen (pressing down a soft key, or the like), the user interface control unit 32 changes the operation screen in accordance with the user operation, but when detecting the wiping operation, the user interface control unit 32 does not change the operation screen.

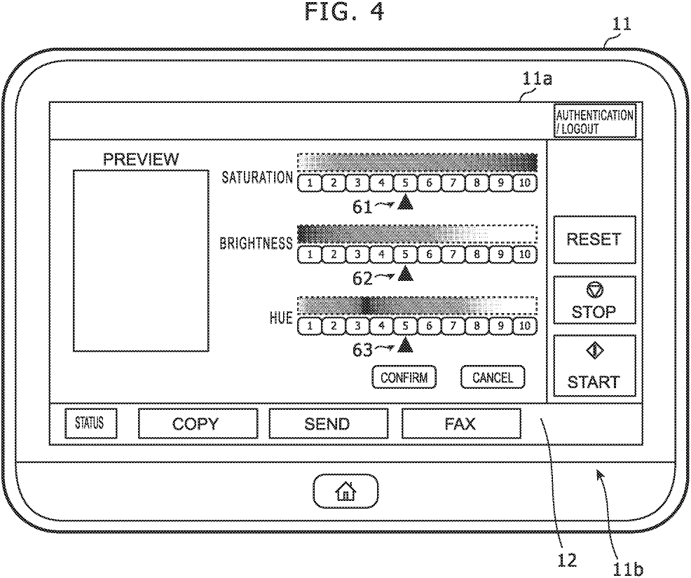

FIG. 4 shows a diagram that indicates an example of an operation screen including a slider. In this embodiment, further, if an operation screen includes sliders 61, 62 and 63 as soft operation parts as shown in FIG. 4 for example, then the user interface control unit 32 does not detect as a wiping operation a touch detected in areas of the sliders 61, 62 and 63 and does not exclude this touch from a user operation to the operation screen, and detects as a wiping operation a touch detected in an areas other than the sliders 61, 62 and 63 and excludes this touch from a user operation to the operation screen.

The following part explains a behavior of the aforementioned image forming apparatus 1.

When the touch panel 12 detect a touch at a touch position, the user interface control unit 32 determines whether a soft operation part (soft key or the like) is at the touch position or not.

If a soft operation part is at the touch position, then the user interface control unit 32 detects a continuous movement of the touch position until the touch is released, and determines whether a distance of the movement exceeds a predetermined distance (e.g. a threshold value corresponding to a size of the soft operation part) or not.

If a distance of the movement exceeds the predetermined distance, then the user interface control unit 32 determines that this touch is a wiping operation and is invalid for an operation to the soft operation part. Contrarily, if a distance of the movement does not exceed the predetermined distance, then the user interface control unit 32 determines that this touch is an operation to the soft operation part, and performs a process (i.e. screen transition, outputting an instruction to the controller 31 such as job request, or the like) corresponding to the operation to the soft operation part.

As mentioned, in the aforementioned embodiment, the display device 11a displays an operation screen, and the touch panel 12 is arranged on the display device 11a. The user interface control unit 32 detects a user operation to the operation screen using the touch panel 12, and performs a process corresponding to the detected user operation. Further, after the touch panel 12 detects a physical touch at a touch position, if the user interface control unit 32 detects a continuous movement of the touch position over a predetermined distance, the user interface control unit 32 detects this touch as a wiping operation, and excludes this touch from a user operation to the operation screen.

Consequently, a wiping operation to the touch panel is properly detected, and an improper behavior due to a wiping operation is restrained.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the user interface control unit 32 may exclude a touch within predetermined time immediately after a detection end of the wiping operation from a user operation to the operation screen. In such a case, an unintentional touch immediately after the wiping operation is not detected in error as a user operation to the operation screen.

Further, in the aforementioned embodiment, if a touch area of the touch is less than a predetermined value (e.g. a touch area by a finger of a user), the user interface control unit 32 may not detect the touch as a wiping operation.

What is claimed is:

1. An electronic apparatus, comprising:
a display device configured to display an operation screen;
a touch panel arranged on the display device; and
a user interface control unit configured to detect a user operation to the operation screen using the touch panel, and perform a process corresponding to the detected user operation;
wherein after the touch panel detects a touch at a touch position, if the user interface control unit detects a continuous movement of the touch position over a predetermined distance, the user interface control unit detects this touch as a wiping operation, and excludes this touch from a user operation to the operation screen.

2. The electronic apparatus according to claim 1, wherein if the operation screen includes a slider, the user interface control unit does not detect a touch in an area of the slider as a wiping operation and does not exclude the touch from a user operation to the operation screen, and detects a touch in an area other than the slider as a wiping operation and excludes the touch from a user operation to the operation screen.

3. The electronic apparatus according to claim 1, wherein when detecting the user operation to the operation screen, the user interface control unit changes the operation screen, but when detecting the wiping operation, the user interface control unit does not change the operation screen.

4. The electronic apparatus according to claim 1, wherein the user interface control unit excludes a touch within predetermined time immediately after a detection end of the wiping operation from a user operation to the operation screen.
